(19) United States
(12) Patent Application Publication
(10) Pub. No.: US 2005/0216865 A1
(43) Pub. Date: Sep. 29, 2005

(54) System and method for device selection in a computer system

(76) Inventors: Kelly Rollin, Seattle, WA (US); Stephane St-Michel, Woodinville, WA (US); Aidan Low, Bellevue, WA (US); Chris J. Guzak, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/813,644

(22) Filed: Mar. 29, 2004

(51) Int. Cl. G06F 3/00

(52) U.S. Cl. 715/839; 715/838; 715/810; 715/734; 715/771

(57) ABSTRACT

A system and method for device selection in a computer system. In certain systems a user may be required to pick a device from a known set of devices. For example, in a video conferencing application, a user may be required to pick which video camera will be utilized for the session. In one embodiment of the invention, the device selection process comprises the following steps. First, the caller creates the device picker (which in turn creates the common file dialog object). Then, the caller may choose an item filter to use and then initializes the device picker with that item filter. Then the device picker displays all the relevant devices in a common file dialog, and the user may choose a device. After a device is chosen, the device picker returns the reference to that device back to the caller.

### FIELD OF THE INVENTION

The embodiment of the present invention relates to a system and method for device selection in a computer system, and more particularly, to a system and method for allowing a user to select a device from all or a subset of the relevant devices in a hardware and devices folder.

### BACKGROUND OF THE INVENTION

In certain known systems and applications a user may be required to pick a device from a known set of devices. For example, in some conferencing applications a task may exist for setting up a video conferencing session, and one of the first things a user may need to do is to pick the video device that is to be utilized for the session (if more than one video device exists). Some of the other examples where users need to pick a device include a movie maker application (during video acquisition), a printer wizard, etc.

In such known systems, there is generally no standard way to select a device from all or a subset of the devices attached to the computer. Instead, each application tends to implement the selection process differently. For example, some known systems include drop-down list boxes where a user is required to click on a down button, after which a list box of items is presented. Once the list box is presented the user then has to select an item and click on an “OK” button. These systems thus require a user to go through multiple steps in order to select a device, and also tend to provide relatively limited information and options for the selection process. Furthermore, because each application implements the selection process differently, the user is typically not provided with a standard way to select a device between different applications. Also, because each application tends to utilize a different process for determining which devices will be included, each application will not necessarily present the same list of devices or present the devices in the same way for a given category.

The embodiment of the present invention is directed to providing a system and method that overcome the foregoing and other disadvantages. More specifically, the present invention is directed to an improved system and method for device selection in a computer system.

### SUMMARY OF THE INVENTION

A system and method for device selection in a computer system is provided. In accordance with one aspect of the invention, a method is provided for a user to select a device from all or a subset of the devices in a hardware and devices folder. In one embodiment, the method may be similar to a common file dialog for selecting files.

In accordance with another aspect of the invention, three components of a device picker are provided, including a device enumeration component, a device selection user interface, and a filtering component. The device enumeration component enumerates all of the relevant devices on the system. The device selection user interface provides a mechanism for the user to select and perform other options with regard to the devices. The filtering component allows an application to select a subset of the devices that are returned by the enumeration.

In accordance with another aspect of the invention, the method that is utilized queries a function discovery database and the query produces a list of available devices. In one implementation, the function discovery database that is utilized is also used by the hardware and devices folder to enumerate its list of devices. By leveraging the function discovery subsystem, the user can be provided with richer information about each device, as well as providing the caller (i.e., the application that utilizes the device picker) with a consistent way to specify which devices to expose.

In accordance with another aspect of the invention, the device selection process comprises the following steps. First, the caller creates the device picker (which in turn creates the common file dialog object). Then, the caller may choose an item filter to use and then initializes the device picker with that item filter. The item filter is an object that can be created by the device picker with help from the caller application, or the caller application can pass in a handle an item filter created by the caller application. Then, the device picker displays all of the relevant devices in a common file dialog, and the user may choose a device from within the common file dialog. After a device is chosen, the device picker returns the reference to that device back to the caller.

In accordance with another aspect of the invention, a user interface is provided that provides information about each device as well as options for selecting the devices and other functions. In one embodiment, all of the relevant devices are provided within the same display area, such that a user is not required to go through the steps of a drop-down list box function which requires several steps in order to select a device. Furthermore, in the user interface a user is able to simply select a device by double-clicking on it. Also, additional information may be provided about each device, including icons, information about when the device was installed, the manufacturer, etc. This type of information is generally not available in a list box-type environment. In one embodiment, the devices within the selector area are also actionable. For example, a user may right-click on a device the same way that they might for an item in a folder, in order to see properties, perform a “send to” function, etc.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a general purpose computer system suitable for implementing the embodiment of the present invention;

FIGS. 2A-2L are block diagrams illustrating various implementations of a programming interface that may be utilized for implementing the embodiment of the present invention;

FIG. 3 is a flow diagram illustrative of a general routine for device selection in a computer system;

FIG. 4 is a flow diagram illustrative of a routine for a user right-clicking on a device within a user interface;

FIG. 5 is a block diagram illustrating the components of a system in which a device picker is implemented;

FIG. 6 is a diagram illustrating a first embodiment of a user interface for a device picker;

FIG. 7 is a diagram illustrating a second embodiment of a user interface for a device picker; and

FIG. 8 is a flow diagram illustrative of a general routine for implementing three components of a device picker system.

### DETAILED DESCRIPTION OF THE PREFERRED EMBODIMENT

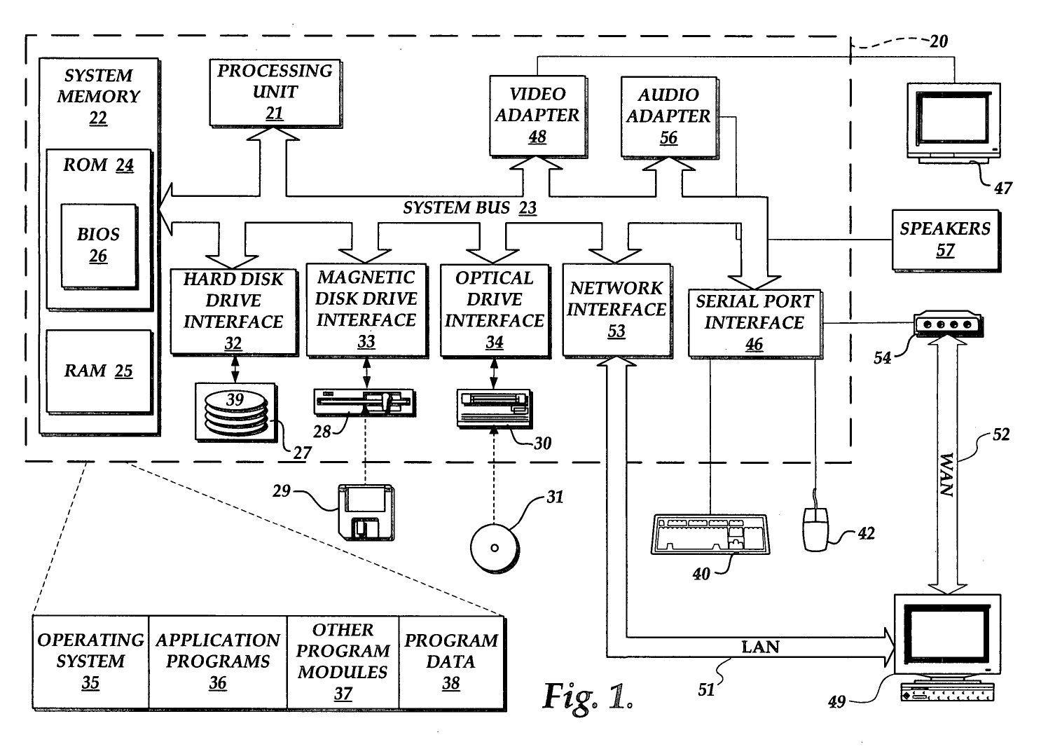

FIG. 1 and the following discussion are intended to provide a brief, general description of a suitable computing environment in which the embodiment of the present invention may be implemented. Although not required, the invention will be described in the general context of computer-executable instructions, such as program modules, being executed by a personal computer. Generally, program modules include routines, programs, characters, components, data structures, etc., that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional personal computer 20, including a processing unit 21, system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that helps to transfer information between elements within the personal computer 20, such as during start-up, is stored in ROM 24. The personal computer 20 further includes a hard disk drive 27 for reading from or writing to a hard disk 39, a magnetic disk drive 28 for reading from or writing to a removable magnetic disk 29, and an optical disk drive 30 for reading from or writing to a removable optical disk 31, such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer-readable instructions, data structures, program modules, and other data for the personal computer 20. Although the exemplary environment described herein employs a hard disk 39, a removable magnetic disk 29, and a removable optical disk 31, it should be appreciated by those skilled in the art that other types of computer-readable media which can store data that is accessible by a computer, such as magnetic cassettes, flash memory cards, digital video disks, Bernoulli cartridges, random access memories (RAMs), read-only memories (ROMs), and the like, may also be used in the exemplary operating environment.

A number of program modules may be stored on the hard disk 39, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may also be connected by other interfaces, such as a parallel port, game port or a universal serial bus (USB). A display in the form of a monitor 47 is also connected to the system bus 23 via an interface, such as a video card or adapter 48. One or more speakers 57 may also be connected to the system bus 23 via an interface, such as an audio adapter 56. In addition to the display and speakers, personal computers typically include other peripheral output devices (not shown), such as printers.

The personal computer 20 may operate in a networked environment using logical connections to one or more personal computers, such as a remote computer 49. The remote computer 49 may be another personal computer, a server, a router, a network PC, a peer device or other common network node, and typically includes many or all of the elements described above relative to the personal computer 20. The logical connections depicted in FIG. 1 include a local area network (LAN) 51 and a wide area network (WAN) 52. The local area network 51 and wide area network 52 may be wired, wireless, or a combination thereof. Such networking environments are commonplace in offices, enterprise-wide computer networks, intranets, and the Internet.

When used in a LAN networking environment, the personal computer 20 is connected to the local area network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20 or portions thereof may be stored in the remote memory storage device. It will be appreciated that the network connections shown are exemplary, and other means of establishing a communications link between the computers may be used.

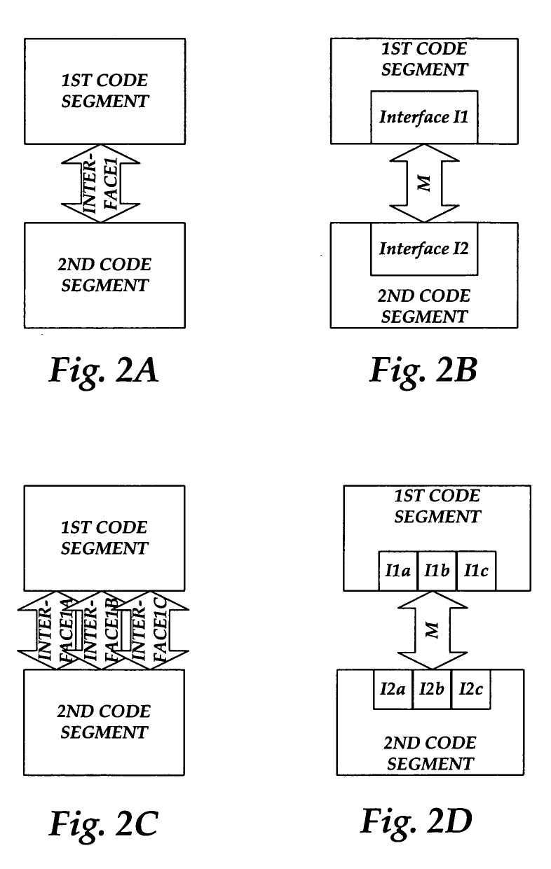

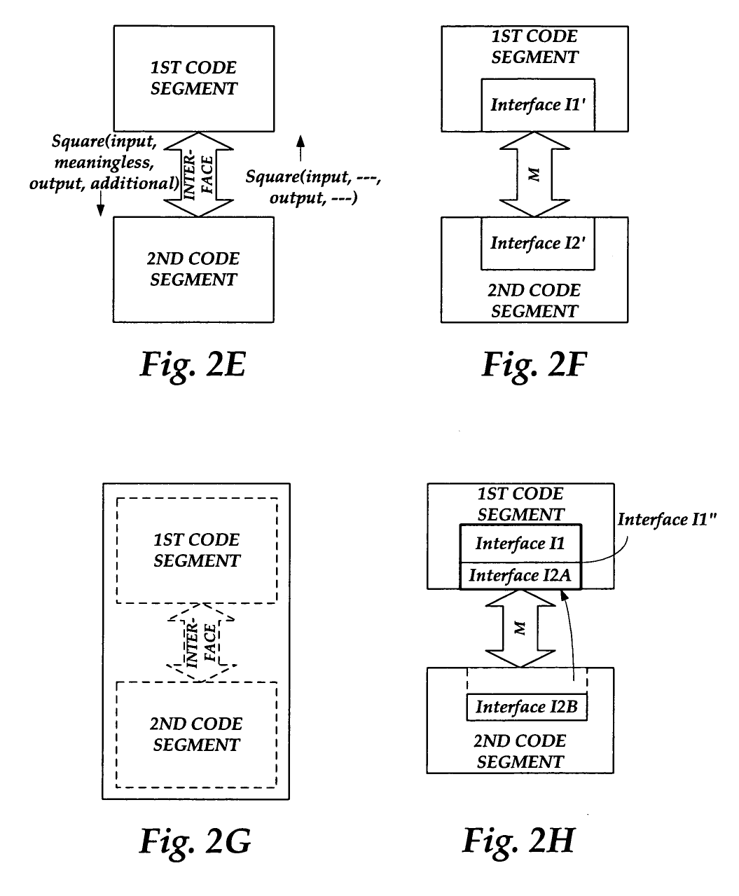

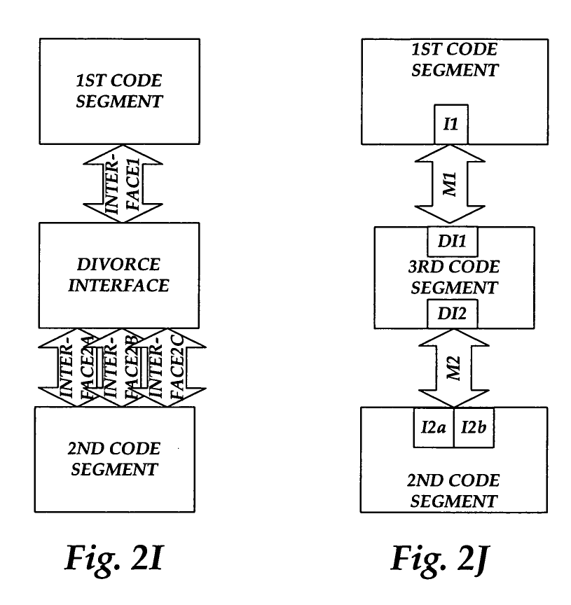

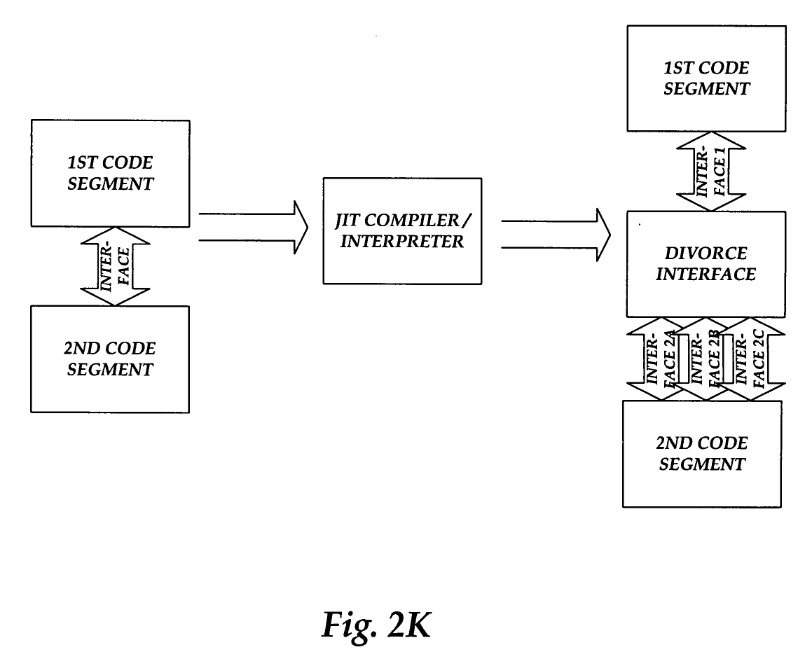

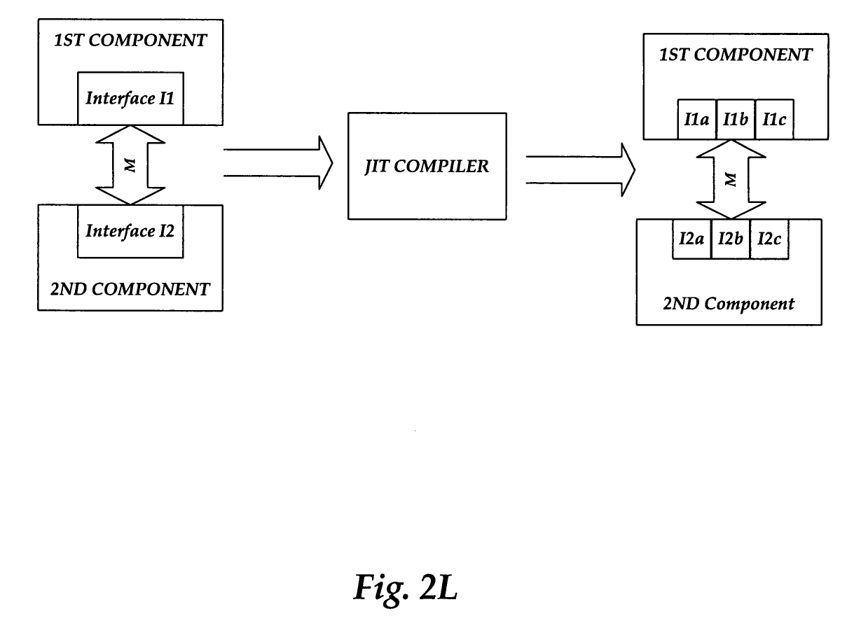

The embodiment of the present invention may utilize various programming interfaces. As will be described in more detail below with respect to FIGS. 2A-2L, a programming interface (or more simply, interface) such as that used in the system may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 2A or FIG. 2B. FIG. 2A illustrates an interface Interface 1 as a conduit through which first and second code segments communicate. FIG. 2B illustrates an interface as comprising interface objects I1 and I2 (which may or may not be part of the first and second code segments), which enable first and second code segments of a system to communicate via medium M. In the view of FIG. 2B, one may consider interface objects I1 and I2 as separate interfaces of the same system and one may also consider that objects I1 and I2 plus medium M comprise the interface. Although FIGS. 2A and 2B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing description. There are, however, other ways to implement a programming interface, and, unless expressly excluded, these too are intended to be encompassed by the claims set forth at the end of this specification. Such other ways may appear to be more sophisticated or complex than the simplistic view of FIGS. 2A and 2B, but they nonetheless perform a similar function to accomplish the same overall result. We will now briefly describe some illustrative alternative implementations of a programming interface.

FIGS. 2C and 2D illustrate a factoring implementation. In accordance with a factoring implementation, a communication from one code segment to another may be accomplished indirectly by breaking the communication into multiple discrete communications. This is depicted schematically in FIGS. 2C and 2D. As shown, some interfaces can be described in terms of divisible sets of functionality. Thus, the interface functionality of FIGS. 2A and 2B may be factored to achieve the same result, just as one may mathematically provide 24, or 2 times 2 time 3 times 2. Accordingly, as illustrated in FIG. 2C, the function provided by interface Interface 1 may be subdivided to convert the communications of the interface into multiple interfaces Interface 1A, Interface 1B, Interface 1C, etc. while achieving the same result. As illustrated in FIG. 2D, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 2C and 2D, the functional spirit of interfaces Interface 1 and I1 remain the same as with FIGS. 2A and 2B, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

FIGS. 2E and 2F illustrate a redefinition implementation. In accordance with a redefinition implementation, in some cases, it may be possible to ignore, add or redefine certain aspects (e.g., parameters) of a programming interface while still accomplishing the intended result. This is illustrated in FIGS. 2E and 2F. For example, assume interface Interface 1 of FIG. 2A includes a function call Square (input, precision, output), a call that includes three parameters, input, precision and output, and which is issued from the 1st Code Segment to the 2nd Code Segment. If the middle parameter precision is of no concern in a given scenario, as shown in FIG. 2E, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 2F, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, that are not needed for some purpose, and so they may be ignored or redefined, or processed elsewhere for other purposes.

FIGS. 2G and 2H illustrate an inline coding implementation. In accordance with an inline coding implementation, it may also be feasible to merge some or all of the functionality of two separate code modules such that the “interface” between them changes form. For example, the functionality of FIGS. 2A and 2B may be converted to the functionality of FIGS. 2G and 2H, respectively. In FIG. 2G, the previous 1 st and 2nd Code Segments of FIG. 2A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface 1 may still be in effect. Similarly, shown in FIG. 2H, part (or all) of interface I2 from FIG. 2B may be written inline into interface I1 to form interface I1″. As illustrated, interface I2 is divided into I2a and I2b, and interface portion I2a has been coded in-line with interface I1 to form interface I1″. For a concrete example, consider that the interface I1 from FIG. 2B performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

FIGS. 2I and 2J illustrate a divorce implementation. In accordance with a divorce implementation, a communication from one code segment to another may be accomplished indirectly by breaking the communication into multiple discrete communications. This is depicted schematically in FIGS. 21 and 2J. As shown in FIG. 2I, one or more piece(s) of middleware (Divorce Interface(s), since they divorce functionality and/or interface functions from the original interface) are provided to convert the communications on the first interface, Interface 1, to conform them to a different interface, in this case interfaces Interface 2A, Interface 2B and Interface 2C. This might be done, e.g., where there is an installed base of applications designed to communicate with, say, an operating system in accordance with an Interface 1 protocol, but then the operating system is changed to use a different interface, in this case interfaces Interface 2A, Interface 2B and Interface 2C. The point is that the original interface used by the 2nd Code Segment is changed such that it is no longer compatible with the interface used by the 1^{st} Code Segment, and so an intermediary is used to make the old and new interfaces compatible. Similarly, as shown in FIG. 2J, a third code segment can be introduced with divorce interface DI1 to receive the communications from interface I1 and with divorce interface D I2 to transmit the interface functionality to, for example, interfaces I2a and I2b, redesigned to work with D I2, but to provide the same functional result. Similarly, D I1 and D I2 may work together to translate the functionality of interfaces I1 and I2 of FIG. 2B to a new operating system, while providing the same or similar functional result.

FIGS. 2K and 2L illustrate a rewriting implementation. In accordance with a rewriting implementation, yet another possible variant is to dynamically rewrite the code to replace the interface functionality with something else but which achieves the same overall result. For example, there may be a system in which a code segment presented in an intermediate language (e.g., Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1 st Code Segment to the 2nd Code Segment, i.e., to conform them to a different interface as may be required by the 2nd Code Segment (either the original or a different 2nd Code Segment). This is depicted in FIGS. 2K and 2L. As can be seen in FIG. 2K, this approach is similar to the divorce configuration described above. It might be done, e.g., where an installed base of applications are designed to communicate with an operating system in accordance with an Interface 1 protocol, but then the operating system is changed to use a different interface. The JIT Compiler could be used to conform the communications on the fly from the installed-base applications to the new interface of the operating system. As depicted in FIG. 2L, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 2A and 2B. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

As will be described in more detail below, there are places within certain operating systems and applications, as well as external partner applications, where a user is required to pick a device. For example, in a messenger program where there is a task to set up video conferencing, one of the first things a user may need to do is to pick the video device that is to be used (if more than one exists). Other examples of where a user may need to pick a device include a movie-maker program (during video acquisition), a printer wizard, etc. However, because in known systems there is not a standard way to accomplish these tasks, each application tends to implement the tasks differently. Known solutions to this problem include drop-down list boxes and a list box of items where the user has to select a device and then hit “OK”. These methods do not query a function discovery database (which in one embodiment is what the Hardware and Devices folder uses to enumerate its list of devices). As will be described in more detail below, by leveraging the function discovery subsystem, the device picker system of the present invention is able to provide the user with richer information about each device as well as providing the caller (the application that uses the device picker) with a consistent way to specify which devices to expose.

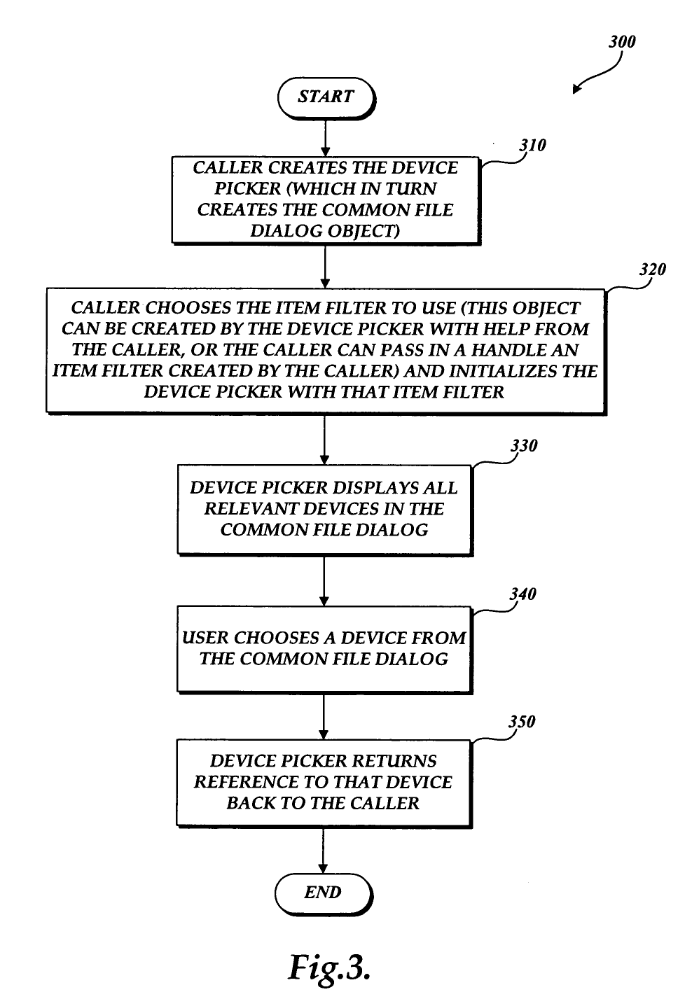

FIG. 3 is a flow diagram illustrative of a general routine 300 for device selection in a computer system in accordance with the embodiment of the present invention. At a block 310, the caller creates the device picker (which in turn creates the common file dialog object). As will be discussed in more detail below, the device picker is utilized for device selection. At a block 320, the caller chooses the item filter to use and initializes the device picker with that item filter. The item filter is an object which can be created by the device picker with help from the caller, or the caller can pass in a handle an item filter created by the caller. At a block 330, the device picker displays all of the relevant devices in the common file dialog. At a block 340, the user chooses a device from the common file dialog. At a block 350, the device picker returns the reference to that device back to the caller.

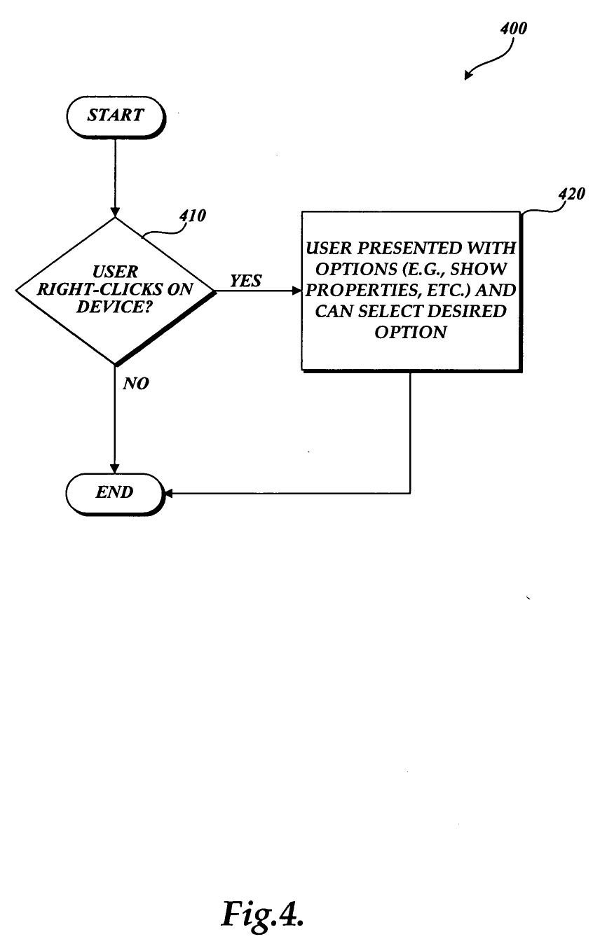

FIG. 4 is a flow diagram illustrative of a routine 400 for a user to perform actionable functions on a device within a user interface. At a decision block 410, a determination is made as to whether the user has right-clicked on the device. If the user has not right-clicked on the device, then the routine ends. If the user has right-clicked on the device, then the routine continues to a block 420, where the user is presented with options (e.g., show properties, etc.) and can select the desired option. In other words, in the device picker user interface, the devices are presented in such a way that they are actionable, similar to how in other systems a user may be able to right-click on an item in a folder, so as to see properties or perform other functions.

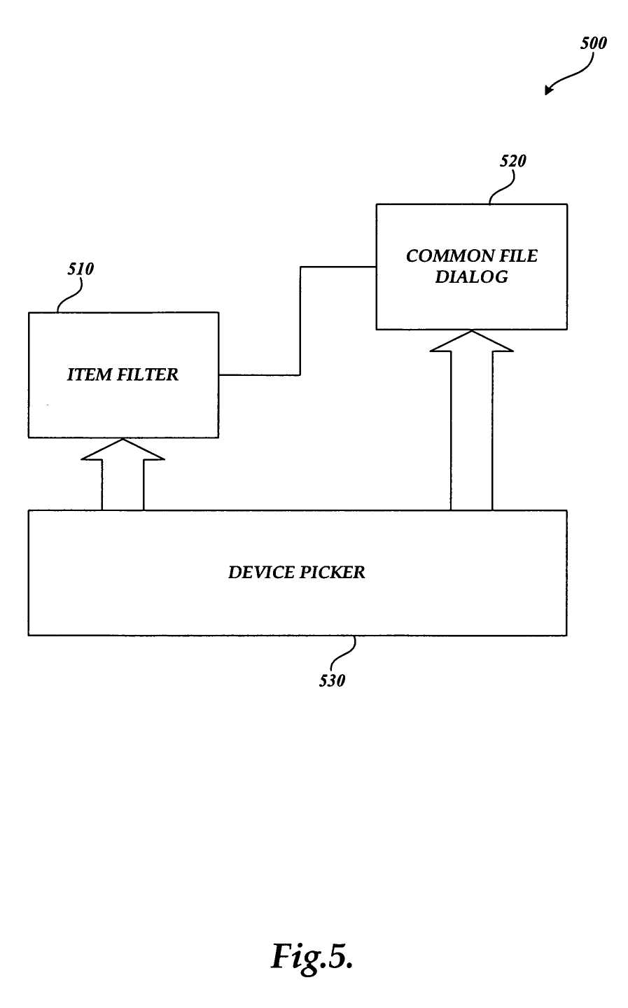

FIG. 5 is a block diagram illustrating the components of a system 500 in which a device picker is implemented. As shown in FIG. 5, the system 500 includes an item filter 510 and a common file dialog 520, which communicate with a device picker 530. In one embodiment, the common file dialog 520 is similar to that used in the known Windows® operating system. This dialog may be created and then populated with items to display to a user. The user is then able to select an item from within this object, which will be returned to the caller of the device picker. The item filter 510 is an object that selects a subset of the devices on the system with which to populate the common file dialog 520. For example, in one embodiment where a camera is being selected, the item filter 510 may include all cameras on the system within the common file dialog.

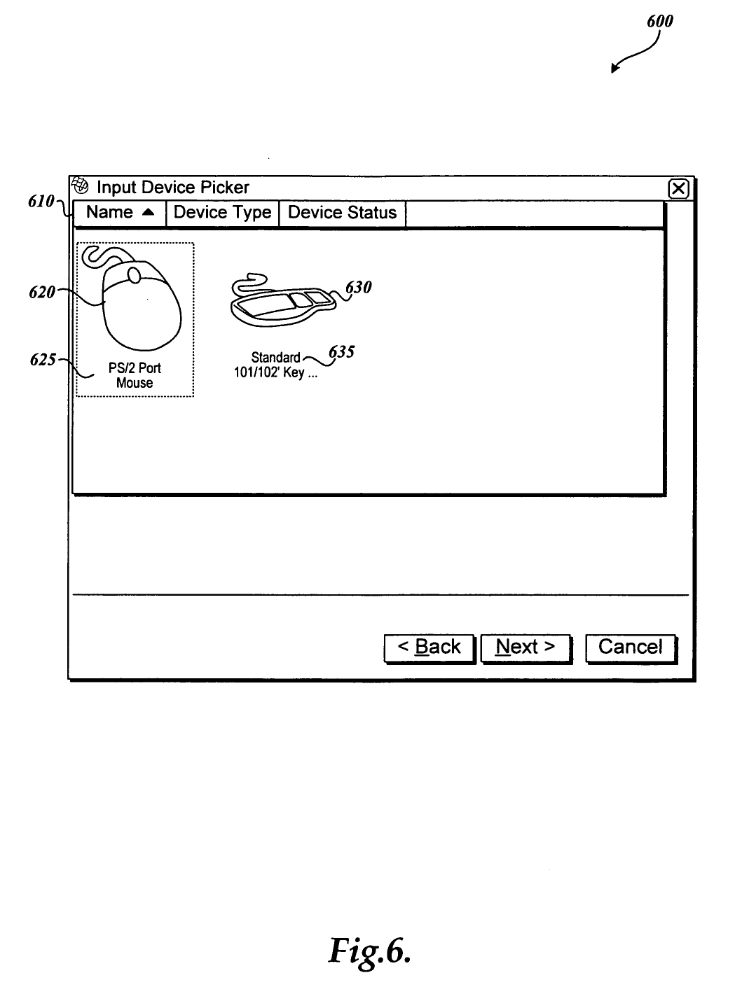

FIG. 6 is a diagram illustrating a first embodiment of a user interface 600 for a device picker. The user interface 600 includes a control bar 610, a mouse icon 620, and a keyboard icon 630. The control bar 610 includes controls such as “name”, “device type”, and “device status”. The mouse icon 620 includes a descriptor 625 which includes text, such as “PS/2 port mouse”. The keyboard icon 630 includes a descriptor 635 which includes text, such as “standard 101/102′ key”. It will be appreciated that the icons 620 and 630, and the descriptors 625 and 635, provide information and options to users that have not previously been available in known device selector systems. More specifically, when compared with a known drop-down list box-type system, wherein only a device name is provided, the icons 620 and 630 and descriptors 625 and 635 provide additional information to a user, as well as being actionable such that the user can perform functions such as right-clicking on the devices or performing other manipulations. The control bar 610 also provides additional mechanisms for manipulating and determining information about the devices.

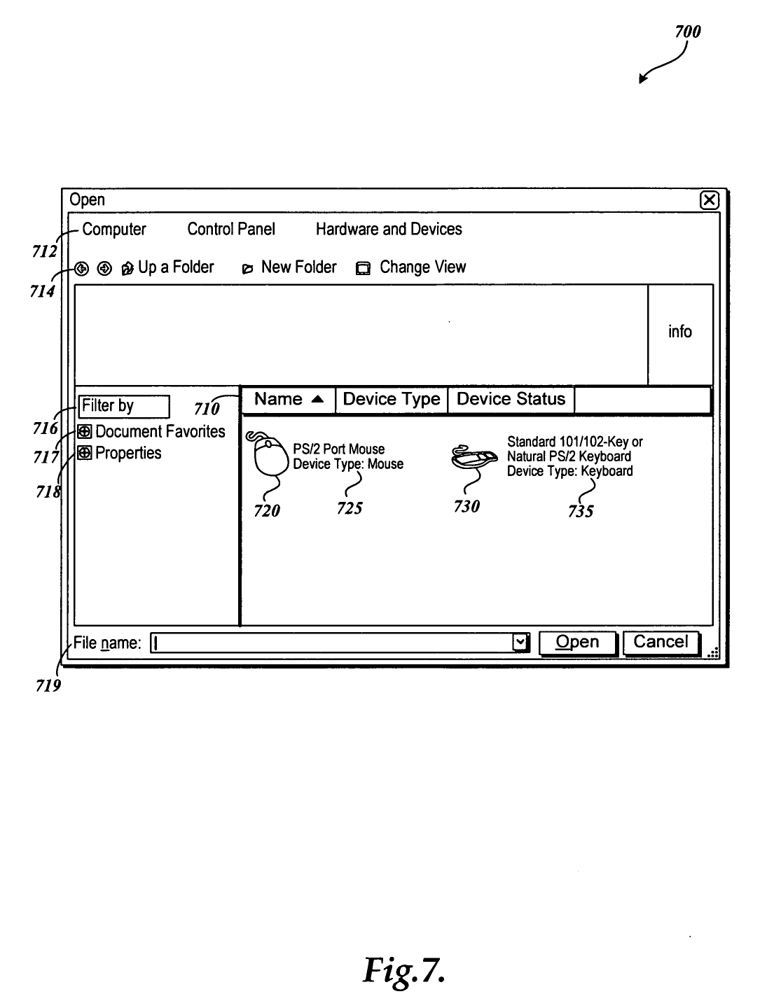

FIG. 7 is a diagram illustrating a second embodiment of a user interface 700 for a device picker. The user interface 700 includes a control bar 710, control areas 712-719, a mouse icon 720, and a keyboard icon 730. The control areas 712-719 include various controls that can be utilized for navigating the computer system with reference to the selection of a device and for additional functions. The filter control 716 permits a user to filter the devices according to a selected parameter. This provides an advantage over known drop-down list box-type systems, in which no mechanism is typically provided for a user to filter the devices. The mouse icon 720 includes a descriptor 725, which includes text such as “PS/2 port mouse”, as well as specifying a device-type of “mouse”. The keyboard icon 730 includes a descriptor 735, which includes text such as “standard 101/102-key or natural PS/2 keyboard”, as well as specifying a device type of “keyboard”.

It will be appreciated that the user interface 700 provides a system for device selection that is similar to a familiar “file/open” function. When the device picker window is opened, the devices are displayed, and then the user may double-click on the device, or type in the name of the device, and then the calling application will receive the information regarding the selected device. As an example, one caller application might be a movie maker, which may require importing video from a live camera, in which case the device picker user interface may be utilized for a user to select a camera to use. It will be appreciated that one of the advantages of the user interface 700 is that it can present all of the devices in a unique way in a single window. This is in contrast to known drop-down list box-type systems, where a user initially has to expand the list box, then is provided with only minimal information about each of the items (e.g., the name) and is typically required to go through multiple steps in order to select the desired device. In one embodiment, the device picker user interface is able to leverage the mechanisms of other file and user interface management tools within the system, and present a unified and consistent way for a user to be presented with and select the desired devices. It will also be appreciated that this also allows the user interface 700 to provide a richer view of the items, including icons and information about the items.

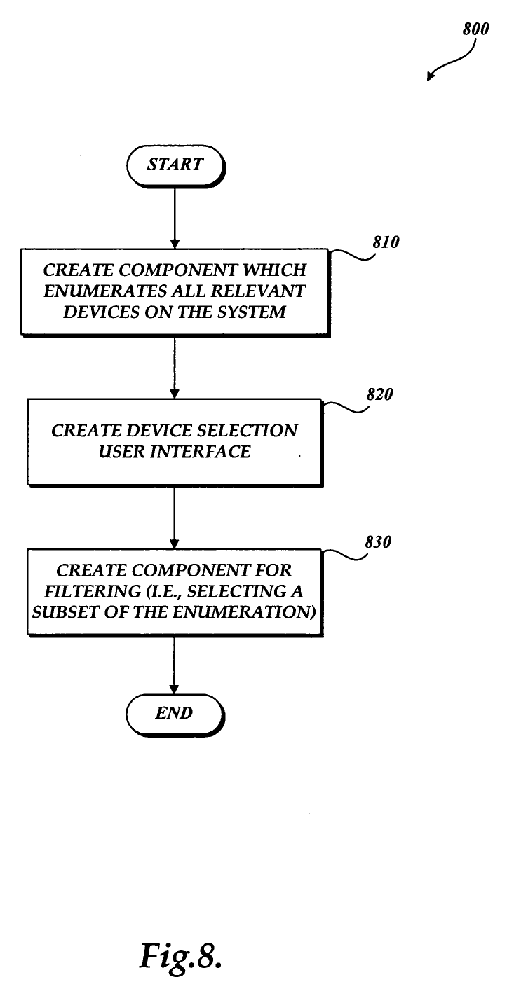

FIG. 8 is a flow diagram illustrative of a general routine 800 for implementing three components of a device picker system. At a block 810, a device enumeration component is created which enumerates all of the relevant devices on the system. At a block 820, a device selection user interface is created for enabling device selection. At a block 830, a filtering component is created that is able to select a subset of the enumeration that is provided by the device enumeration component.

It will be appreciated that the device picker system of the present invention provides a standard way for a user to select a device from all or a subset of the devices in a hardware and devices folder. In the same way that a common file dialog may work for selecting files, the device picker may work for selecting devices. Various aspects of the common file dialog may be utilized in the implementation of the device picker system.

While the preferred embodiment of the invention has been illustrated and described, it will be appreciated that various changes can be made therein without departing from the spirit and scope of the invention.

1. A method for device selection in a computer system, the method comprising:
a caller creating a device picker;
the device picker displaying all of the relevant devices;
a user selecting a device; and
the device picker returning a reference to the selected device back to the caller.

2. The method of claim 1, wherein when the caller creates the device picker it in turn creates a common file dialog object.

3. The method of claim 2, wherein when the device picker displays all of the relevant devices it does so in the common file dialog.

4. The method of claim 3, wherein when the user selects the device it does so from the common file dialog.

5. The method of claim 1, further comprising the caller choosing an item filter to use.

6. The method of claim 5, wherein the item filter is created by the caller and the device picker is initialized with the item filter.

7. The method of claim 5, wherein the item filter is passed by the caller and the device picker is initialized with the item filter.

8. The method of claim 5, wherein the item filter is created by the device picker.

9. The method of claim 1, wherein the relevant devices are displayed in a user interface where a user can click on a device to select it such that a drop-down list box is not required for selecting the devices.

10. The method of claim 9, wherein the user interface includes icons for the devices.

11. The method of claim 9, wherein the user interface includes descriptions of the device types.

12. The method of claim 9, wherein the user interface includes the names of the devices in addition to additional information about each of the devices.

13. The method of claim 9, wherein the devices in the user interface are actionable.

14. The method of claim 13, wherein the actionability of the devices includes a user being able to right-click on the devices to perform actions such as viewing the device properties.

15. A system for device selection comprising:
a device enumeration component;
a filtering component; and
a device selection user interface.

16. The system of claim 15, wherein the user interface includes icons for the devices.

17. The system of claim 15, wherein the user interface includes descriptions of the device types.

18. The system of claim 15, wherein the devices in the user interface are actionable.

19. The system of claim 18, wherein the actionability of the devices includes a user being able to right-click on the devices to perform actions such as viewing the device properties.

20. The system of claim 15, wherein devices are displayed in the user interface where a user can click on a device to select it such that a drop-down list box is not required for selecting the devices.

21. The system of claim 15, wherein the filtering component utilizes a filter that is specified by a caller.

22. The system of claim 15, wherein the filtering component utilizes a filter that is specified by a user.

23. A method for device selection in a computer system, the method comprising:
receiving a call for device selection; and
in response to receiving the call, enumerating a set of devices from which a user can make a selection, and returning a reference to the selected device back to the caller.

24. The method of claim 23, wherein the caller creates a device picker, which in turn creates a common file dialog object.

25. The method of claim 24, wherein when the device picker displays all of the relevant devices it does so in the common file dialog.

26. The method of claim 25, wherein when the user selects the device it does so from the common file dialog.

27. The method of claim 23, further comprising the user selecting an item filter to use.

28. The method of claim 23, wherein the relevant devices are displayed in a user interface where a user can click on a device to select it such that a drop-down list box is not required for selecting the devices.

29. The method of claim 28, wherein the user interface includes icons for the devices.

30. The method of claim 28, wherein the devices in the user interface are actionable.

31. One or more computer-readable media for enabling a computer-program segment which may require a device selection to communicate with one or more other computer-program segments, said media comprising:
a set of computer-usable instructions to cause a request to have a user select a device and to return an indication of the user's selected device to be communicated to one or more other computer-program segments capable of executing said requests.

32. The media of claim 31, wherein the devices are displayed in a user interface where a user can click on a device to select it such that a drop-down list box is not required for selecting the devices.

33. The media of claim 32, wherein the user interface includes icons for the devices.

34. The media of claim 32, wherein the devices in the user interface are actionable.

35. The media of claim 31, wherein a filter is utilized that can be selected and adjusted by the user.

36. The media of claim 31, wherein a common file dialog object is utilized as part of the device selection process.

37. The media of claim 36, wherein a common file dialog is utilized for displaying a set of devices to the user.

38. One or more computer-readable media for enabling a computer-program segment which requires a device selection to communicate with one or more other computer-program segments, said media comprising:
a set of computer-usable instructions that cause a request to return a device selection to be communicated to one or more other computer-program segments capable of executing said request, wherein the relevant devices are displayed in a user interface where a user can click on a device to select it, such that a drop-down list space box is not required for selecting the devices.

39. The media of claim 38, wherein the user interface includes icons for the devices.

40. The media of claim 38, wherein the devices in the user interface are actionable.

41. The media of claim 38, wherein a filter is utilized.

42. The media of claim 41, wherein the user can select and adjust the filter.
